(19) United States
(12) Patent Application Publication
(10) Pub. No.: US 2004/0170841 A1
(43) Pub. Date: Sep. 2, 2004

(54) Process for producing cleaning blade, and electrophotographic apparatus

(75) Inventors: Takashi Tomiyama, Ibaraki (JP); Hironori Oohashi, Ibaraki (JP)

Correspondence Address: FITZPATRICK CELLA HARPER & SCINTO, 30 ROCKEFELLER PLAZA, NEW YORK, NY, 10112, US

(73) Assignee: CANON KASEI KABUSHIKI KAISHA, IBARAKI (JP)

(21) Appl. No.: 10/787,303

(22) Filed: Feb. 27, 2004

(30) Foreign Application Priority Data
Feb. 28, 2003 (JP) 2003-053774

(51) Int. Cl. B32B 1/00

(52) U.S. Cl. 428/422.8

(57) ABSTRACT

In a process for producing a cleaning blade, a blade formed of a urethane resin is impregnated with an isocyanate compound at its surface portion. Thereafter, warm air or hot air is blown on the blade surface to remove the isocyanate compound remaining thereon, and then the urethane resin that forms the blade is allowed to react with the isocyanate compound with which the blade stands impregnated, to form a cured layer.

### BACKGROUND OF THE INVENTION

1. Field of the Invention

This invention relates to a process for producing a cleaning blade used to remove toner remaining on toner holding members such as a photosensitive drum, a transfer belt and an intermediate transfer member in an electrophotographic apparatus, and an electrophotographic apparatus in which the cleaning blade is set.

2. Related Background Art

Electrophotographic apparatus making use of toners are in wide use, where toner remaining after transfer (transfer residual toner) is present on the above various toner holding members, and it is prevalent to wipe off them with cleaning blades in order to remove the transfer residual toner.

Cleaning blades provided for these are often made from urethane resins having rigidity, flexibility and heat resistance to a certain degree.

In such cleaning blades made of urethane resins, the urethane resin is so greatly frictional against the toner holding members that the cleaning blades may be turned up or the toner holding members must be driven at a large torque, and also that the portions of cleaning blades at which they come into contact with the toner holding members (hereinafter called “contact portion(s)”) may be caught on, or drawn over, the toner holding members to come to cut or chip in some cases. These problems may remarkably arise especially when the cleaning blades themselves have a low hardness, resulting in a lack of cleaning blade durability.

To solve such problems the cleaning blades made from urethane resins have, a cleaning blade and a process for producing the cleaning blade are proposed in which the blade is provided, only at its portion coming into contact with a toner holding member, with a cured layer of 0.12 to 1.2 mm in thickness that has been formed by reaction of the cleaning blade base material, urethane resin, with an isocyanate compound (Japanese Patent Application Laid-open No. 2001-343874).

In the process of forming the cured layer at the surface portion of the cleaning blade base member urethane resin blade, the surface portion of the blade formed of the urethane resin is impregnated with the isocyanate compound, and after the impregnation, the isocyanate compound remaining in excess on the blade surface is removed, then the urethane resin is allowed to react with the isocyanate compound with which the blade stands impregnated, to form the cured layer. In this production process, fine raised portions are formed on the surface of the cured layer if the isocyanate compound remaining in excess on the blade surface is removed in a locally non-uniform state. Such raised portions cause faulty cleaning in which the toner slips through the blade around the raised portions when the toner remaining on a toner holding member is removed by cleaning.

### SUMMARY OF THE INVENTION

Accordingly, an object of the present invention is to provide a process for producing a cleaning blade that does not cause any toner slip-through.

Another object of the present invention is to provide an electrophotographic apparatus having the cleaning blade thus produced.

The process for producing a cleaning blade according to the present invention is characterized by having the steps of:

(1) impregnating with an isocyanate compound at least part of the surface portion of a blade formed of a urethane resin;

(2) after the impregnation, blowing warm air or hot air on the blade surface to remove the isocyanate compound remaining on the blade surface; the warm air or hot air having a temperature not lower than the melting point of the isocyanate compound; and

(3) allowing the urethane resin forming the blade to react with the isocyanate compound with which the blade stands impregnated, forming a cured layer.

The present invention can also provide an electrophotographic apparatus having superior cleaning performance, by applying to the electrophotographic apparatus the cleaning blade thus produced.

### BRIEF DESCRIPTION OF THE DRAWINGS

FIGS. 1A and 1B are diagrammatic views to illustrate the cleaning blade according to the present invention.

FIGS. 2A, 2B, 2C, 2D, 2E, 2F and 2G are diagrammatic views to illustrate the cleaning blade according to the present invention.

FIG. 3 is a schematic view of an example of the electrophotographic apparatus in which the cleaning blade according to the present invention is set.

### DETAILED DESCRIPTION OF THE PREFERRED EMBODIMENTS

In the production process according to the present invention, the blade surface portion is impregnated with an isocyanate compound, and thereafter any excess isocyanate compound remaining on the blade surface is removed by blowing warm air or hot air, whereby the excess isocyanate compound can be removed without causing lacal unevenness. This enables the problem of toner slip-through to be solved.

In the production process according to the present invention, the warm air or hot air to be blown to remove the excess isocyanate compound remaining on the blade surface, various gases may be used, as exemplified by air, nitrogen and argon. In order to blow off the isocyanate compound with the warm air or hot air, the temperature of the warm air or hot air is so set as to be not lower than the melting point of the isocyanate compound.

In order to more sufficiently remove the isocyanate compound remaining on the blade surface, it is also effective that the step of removing with a solvent the isocyanate compound remaining on the blade surface is further provided between the step of treatment with the warm air or hot air and the step of allowing the urethane resin to react with the impregnating isocyanate compound (herein meant to be the isocyanate compound with which the blade stands impregnated).

The simplest method by which the blade surface portion is impregnated with the isocyanate compound is to immerse the blade in an isocyanate compound bath. It is also effective to optionally carry out treatment with an active hydrogen compound causative of no cross-linking reaction, to deactivate excess unreacted isocyanate groups of the isocyanate compound.

It is preferable that the contact portion of the cleaning blade, at which the blade comes into contact with the toner holding member, is a cured layer composed of a reaction product of the urethane resin with the isocyanate compound and that the contact portion has a ten-point average roughness Rz (JIS B0601) of 5 μm or less.

In addition, the contact portion may preferably have a hardness of from 60° to 90° as the international rubber hardness IRHD (JIS K6253).

It is further preferable that the cleaning blade has, at the above contact portion, an IRHD that is 1° to 10° larger than the IRHD at the portion where the cured layer is not formed.

It is also preferable that, at the contact portion, the cured layer has a thickness of from 0.12 mm to 0.8 mm, and the thickness of the cured layer is 70% or less of the thickness of the cleaning blade.

The cleaning blade for electrophotography according to the present invention is constituted of a cross-sectionally rectangular elastic material portion formed of a urethane resin and a support member formed of a metal, a hard plastic or the like. The edge portion of this elastic material portion formed of a urethane resin comes into contact with the toner holding member to wipe off the toner remaining on the toner holding member.

In the present invention, this elastic material formed of a urethane resin, i.e., the cleaning blade must have, at its portion coming into contact with the toner holding member (the contact portion), a cured layer in which the base material urethane resin has reacted with the isocyanate compound, namely, allophanate linkages have been formed.

More specifically, urethane linkages having active hydrogen are present in the urethane resin that forms the cleaning blade. In the present invention, this urethane linkages are allowed to react with the impregnating isocyanate compound to form the allophanate linkages. Thus the cured layer is formed. Also, it is considered that reaction of isocyanate compounds with each other (carbodiimidization, isocyanation or the like) proceeds simultaneously to contribute to the formation of the cured layer.

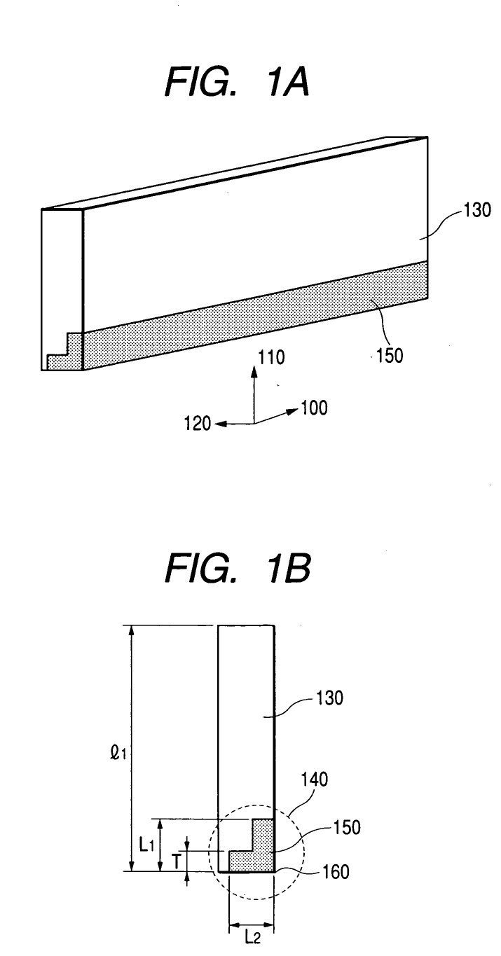

FIGS. 1A and 1B show an example of the cleaning blade according to the present invention. In this example, a cured layer 150 having a sectional shape that is L-shaped in the free-length direction 110 and the thickness direction 120 of the cleaning blade is formed only at a contact portion 140 coming into contact with a toner holding member, inclusive of an edge 160, and is formed uniformly with respect to the lengthwise direction 100 of the cleaning blade.

In the present invention, the cured layer is formed only at the contact portion 140, and hence the rubber elasticity of a free-length portion 130 is retained. Hence, the cleaning blade can be kept from having too high rigidity as a whole, realizing a good action following the toner holding member and excellent cleaning performance. Also, good close-contact performance is achieved between the toner holding member and the cleaning blade, and the toner holding member is kept from being damaged by the cleaning blade.

In addition, the free-length portion refer to a portion which is not treated with the isocyanate compound and in which the cured layer is not formed, and is also referred to as an untreated portion.

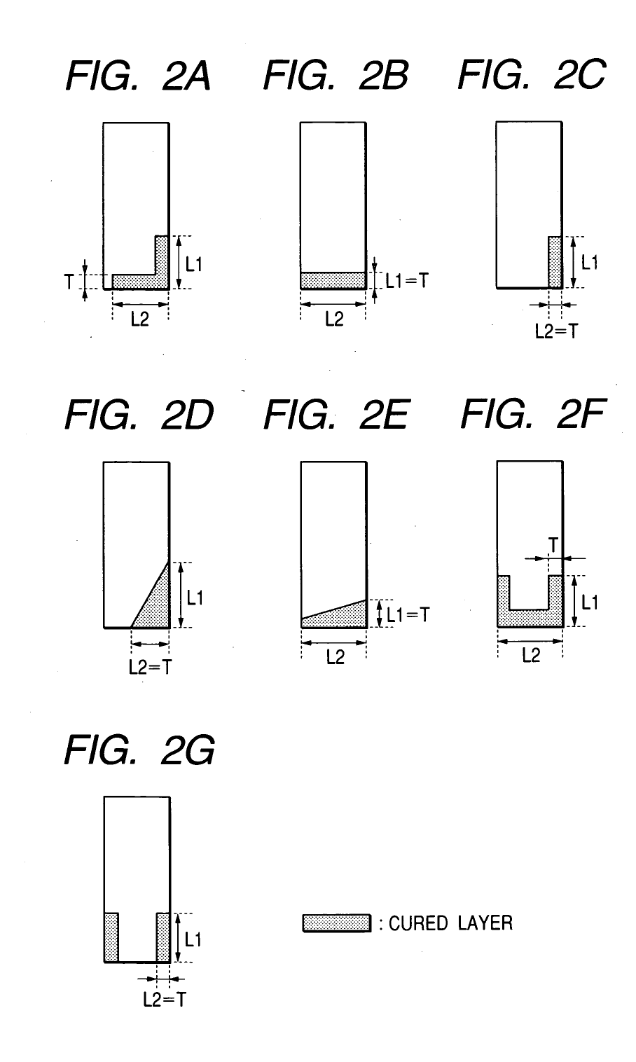

As the sectional shape of the cured layer, it can be exemplified by, as shown in FIGS. 2A to 2G, an L-shape (FIG. 2A), rectangular shapes (FIGS. 2B and 2C), a triangular shape (FIG. 2D), a trapezoid shape (FIG. 2E), a U-shape (FIG. 2F) and a parallel shape (FIG. 2G). The U-shape (FIG. 2F) or the parallel shape (FIG. 2G) is preferred taking into account productivity, cleaning blade elasticity and so forth.

Herein, L1 represents the length of the cured layer in its free-length direction; L2, the length of the cured layer in its thickness direction; and T, the thickness of the cured layer. As shown in FIGS. 2C to 2E, there may be cases in which T is equal to L1 and/or L2. In addition, the free length refers to the length in the free-length direction in which the cleaning blade is extended out of its support member, and may commonly be from 5 mm to 15 mm.

As to the lengths L1 and L2, there are no particular limitations thereon as long as they are each long enough for the cured layer to be present at least at the contact portion of the cleaning blade coming into contact with the toner holding member. In order to make sufficient at the contact portion the effect attributable to the cured layer, the L1 may preferably be 1 mm or more, and more preferably 2 mm or more. In addition, it is desirable for the L1 to be set 30% to 80% of the free length in order to secure the flexibility of the cleaning blade. The L2 may preferably be 0.2 mm or more, and more preferably 0.5 mm or more, and still more preferably 1 mm or more. It is set not larger than the thickness of the cleaning blade.

The T may also preferably be 0.12 mm or more, and more preferably 0.15 mm or more because too small T may possibly lower the blade durability, and may preferably be 0.8 mm or less.

As long as the thickness of the cured layer is within such ranges, good surface properties of the contact portion of the cleaning blade can be maintained over a long period of time even if the contact portion of the cleaning blade has worn. Moreover, since the cured layer has a sufficient thickness, the contact portion of the cleaning blade can be kept from being greatly deformed because of its sliding against the toner holding member. Hence, any fine toners and spherical toners which are being frequently used in recent years can also effectively be removed.

The hardness of the urethane resin blade at its part having the cured layer, which hardness comes high upon the formation of the cured layer, may preferably be approximately from 60° to 90° as the IRHD because too high hardness may make the toner holding member damaged by the cleaning blade. In addition, this hardness may preferably be larger approximately by from 1° to 15°, and more preferably from 1° to 10°, than the hardness of the base member urethane resin blade.

The hardness and thickness of the base member urethane resin blade in the present invention may be the hardness and thickness commonly used in cleaning blades. It may usually be approximately from 50° to 80° in the IRHD and be approximately from 0.5 mm to 3 mm in thickness.

In virtue of the effect attributable to the cured layer in the present invention, the friction of the cleaning blade against the toner holding member at the contact portion is greatly reduced. In addition, the degree of the friction of the cleaning blade against the toner holding member at the contact portion may appropriately be controlled by adjusting the thickness of the cured layer. More specifically, the coefficient of friction decreases gradually with an increase in the thickness of the cured layer. Here, the coefficient of friction may preferably be 2.0 or less, and more preferably 1.5 or less, from the viewpoint of sliding characteristics of the cleaning blade. The coefficient of friction also decreases consequently with an increase in the thickness of the cured layer. Since, however, the rubberiness may lower to make it unable to clean the toner holding member, the cured layer and the coefficient of friction may appropriately be controlled by the construction of the blade main body. In addition, in the present invention, the coefficient of friction is measured with HEIDON Surface Tester (manufactured by Shinto Kagaku K.K.), moving a 0.1-kg-loading ball penetrator made of stainless steel, at a rate of 50 mm/minute.

The base member cleaning blade made of urethane resin in which blade the cured layer has not been formed is produced from a polyisocyanate compound and a polyfunctional active hydrogen compound.

As the polyisocyanate compound used here, it is preferable to use a prepolymer of a usual polyisocyanate with a polymeric polyol which is a polyfunctional active hydrogen compound. The prepolymer may preferably have an isocyanate group content (NCO %) of from 5% by weight to 20% by weight in order to achieve good elastic properties. Here, the polymeric polyol as a polyfunctional active hydrogen compound may include, as specific examples, polyester polyol, polyether polyol, caprolactone ester polyol, polycarbonate ester polyol, and silicone polyol. It is suitable for any of these to have a weight-average molecular weight of usually from 500 to 5,000. The polyisocyanate may also include, as specific examples, diphenylmethanediisocyanate (MDI), tolylenediisocyanate (TDI), naphthalenediisocyanate (NDI), and hexamethylenediisocyanate (HDI).

In addition, the isocyanate group content (NCO %) refers to the percent by weight of isocyanate functional groups (NCO, calculated as molecular weight of 42) contained in the prepolymer or a semi-prepolymer, which is the raw material of the urethane resin, and is calculated according to the following expression. NCO %=(isocyanate functional group equivalent weight in 100 g)×42

A cross-linking agent may also be added. The cross-linking agent may include, as specific examples, 1,4-butanediol, 1,6-hexanediol, ethylene glycol, and trimethylol propane.

When the isocyanate compound is reacted with the polymeric polyol, the polyisocyanate and the cross-linking agent, a catalyst may be added which is usually used for forming the urethane resin. Such a catalyst may include, as specific examples, triethylenediamine and the like.

The cleaning blade in which the cured layer has not been formed is obtained by molding. Methods therefor may include:

(1) a one-shot method in which the polymeric polyol, the polyisocyanate, the cross-linking agent and the catalyst are mixed at a time, and the resultant mixture is casted into a mold or a centrifugal molding cylindrical mold to carry out molding;

(2) a prepolymer method in which the polymeric polyol and the polyisocyanate are preliminarily reacted to form a prepolymer, followed by mixing with the cross-linking agent and the catalyst, and the resultant mixture is casted into a mold or a centrifugal molding cylindrical mold to carry out molding; and

(3) a semi-one-shot method in which a semi-prepolymer formed by reacting the polymeric polyol with the polyisocyanate is reacted with a curing agent prepared by adding a polymeric polyol to the cross-linking agent, and the resultant product is casted into a mold or a centrifugal molding cylindrical mold to carry out molding.

Alternatively, a urethane resin sheet having a thickness required as the cleaning blade may be prepared, and, from this sheet, a sheet may be cut in a size of the cleaning blade to obtain the base member cleaning blade in which the cured layer has not been formed.

When the above methods (1) to (3) are used, the cleaning blade made of the urethane resin may directly be formed on a support member. The support member may also be attached to a cleaning blade in which the cured layer has been formed by a method as described below.

A method is described by which the cured layer according to the present invention is formed in the base member cleaning blade made of urethane resin (herein often “urethane resin blade”) obtained as described above.

The cleaning blade having the cured layer can be formed through the following steps.

That is, it can be produced through steps having a step (1) of impregnating the urethane resin blade with an isocyanate compound at least at the contact portion of the cleaning blade coming into contact with the toner holding member; a step (2) of removing any excess isocyanate compound remaining on the urethane resin blade surface, by blowing thereon the warm air or hot air as described previously, and optionally by further using a solvent; and a step (3) of allowing the urethane resin to react with the impregnating isocyanate compound.

More specifically, in the step (1), the urethane resin blade is impregnated with the isocyanate compound in an appropriate quantity. Here, urethane linkages having active hydrogen are present in the urethane resin that forms the cleaning blade. In the step (3), this urethane linkages are allowed to react with the impregnating isocyanate compound to form the cured layer formed chiefly of allophanate linkages. Also, it is considered that the reaction of polymerizing the isocyanate compound proceeds simultaneously to contribute to the formation of the cured layer. As a result, the hardness of the cleaning blade is sufficiently improved, the coefficient of friction is sufficiently made low, and the durability of the cleaning blade can be improved.

In the present invention, the isocyanate compound with which the urethane resin blade is impregnated may be any compound as along as it has at least one isocyanate group in the molecule.

As an isocyanate compound having one isocyanate group in the molecule, it may include aliphatic monoisocyanates such as octadecylisocyanate (ODI), and aromatic monoisocyanates.

As an isocyanate compound having two isocyanate groups in the molecule, it may include tolylene-2,4-diisocyanate, tolylene-2,6-diisocyanate, diphenylmethane-4,4′-diisocyanate (MDI), m-phenylenediisocyanate, tetramethylenediisocyanate, and hexamethylenediisocyanate.

In the present invention, also usable are an isocyanate compound having three or more isocyanate groups, such as triphenylmethane-4,4′,4″-triisocyanate, biphenyl-2,4,4-triisocyanate, diphenylmethane-2,4,4′-triisocyanate, and modified derivatives, polymers or the like of isocyanate compounds having two or more isocyanate groups.

When the urethane resin blade is impregnated with the isocyanate compound having two or more isocyanate groups to allow the latter to react with the urethane resin, in the present invention, any excess isocyanate compound not reacting with the urethane resin forms a polymer in itself, or reacts with water present in environment to form a polymer having an urea linkage. Hence, in addition to a cross-linked structure composed of the isocyanate compound and the urethane resin, a network structure composed of a polymer of the isocyanate compound is further formed in the cured layer. As a result, the durability of the cured layer is further improved. In addition, even if any superfluous isocyanate compound is present, a structure may be provided in which superfluous unreacted isocyanate groups of the isocyanate compound are deactivated with an active hydrogen compound causative of no cross-linking reaction and also molecular chains having no active hydrogen of the compound hang on the cured layer. Hence, the degree of friction can effectively be reduced.

Of the isocyanate compounds as exemplified above, aliphatic isocyanate compounds less in steric hindrance and isocyanate compounds having a small molecular weight have superior permeability, and hence make it easy to control the thickness of the cured layer to be formed. Also, many of them show a relatively low viscosity at the time of melting, and hence, when impregnated therewith, inclusion of foams is reduced, and hence the isocyanate compound can be allowed to react uniformly with the urethane resin. On the other hand, isocyanate compounds having a large molecular weight have inferior permeability, but are long-chain, and hence are less volatile, so that they are relatively low toxic and have superior operating safety.

In the present invention, in order to accelerate polymerization reaction of the isocyanate compound, the urethane resin blade may also be impregnated with, in addition to the isocyanate compound, a polymerization catalyst of the isocyanate compound.

Examples of the polymerization catalyst used together with the isocyanate compound may include quaternary ammonium salts and carboxylates. As the quaternary ammonium salts, they may be exemplified by a TMR catalyst, available from DABCO Co. As the carboxylates, they may be exemplified by potassium acetate and potassium octylate. These polymerization catalysts are very viscous, or are solid at the time of impregnation. Accordingly, it is preferable for such a catalyst to be beforehand dissolved in a solvent and then added to the isocyanate compound with which the urethane resin blade is impregnated.

In the present invention, when the urethane resin blade is impregnated with the isocyanate compound, the urethane resin blade may be in a single member, or may be in a state that it is joined to a support member with no problem. Also, a sheet having not been cut into the urethane resin blade may be impregnated with the isocyanate compound to effect reaction, and thereafter the sheet may be cut into the urethane resin blade. The region of the urethane resin blade within which the blade is to be impregnated with the isocyanate compound includes at least the end portion where the cleaning blade comes into contact with the toner holding member, and has the stated values of L1 and L2.

The urethane resin blade is impregnated with the isocyanate compound by, e.g., immersing the urethane resin blade in a liquid of the isocyanate compound at a temperature at which the isocyanate compound is kept liquid. Methods therefor may also be exemplified in which a fibrous member or a porous member is impregnated with the isocyanate compound, the urethane resin blade is coated with the isocyanate compound, or the urethane resin blade is coated with the isocyanate compound by spraying.

Thus, the urethane resin blade is impregnated with the isocyanate compound at a stated temperature and for a stated time. In order that the thickness of the cured layer of the cleaning blade to be finally obtained is controlled within the desired range, the time for impregnation with the isocyanate compound may preferably be set to be 1 minute or more, and preferably 60 minutes or less. Also, the temperature for impregnation is the temperature at which the isocyanate compound is kept liquid. The higher the temperature is, the higher the rate of impregnation is. From the viewpoint of heat deterioration of the isocyanate compound, this temperature may preferably be from 30° C. or more to 120° C. or less.

Next, in the step (2), the excess isocyanate compound remaining on the urethane resin blade surface (the excess isocyanate compound) is removed by blowing thereon the warm air or hot air as described previously, and optionally by further wiping it off with a solvent capable of dissolving the isocyanate compound. If the isocyanate compound remains in excess on the blade surface, the isocyanate compound may react with water present in the air to form a urea resin, and consequently a hard urea resin layer comes to be formed on the urethane resin blade surface, and hence this may cause damage of rubber elasticity. Also, the isocyanate compound, which is solid at room temperature, is heated and melted to impregnate the blade therewith. In such a case, if time has elapsed beyond a certain time before the removal, the isocyanate compound having stood molten may solidify, and hence may come very difficult to remove.

Accordingly, the step is required in which, before the isocyanate compound remaining on the urethane resin blade surface solidifies, it is sufficiently removed by blowing thereon the warm air or hot air, and optionally by further using the solvent capable of dissolving the isocyanate compound.

When the excess isocyanate compound is removed by blowing the warm air or hot air, the gas such as air, nitrogen or argon may be used, and the warm gas or hot gas is blown on the blade surface at a temperature not lower than the melting point of the isocyanate compound. The warm gas or hot gas (e.g., hot air of 50° C.) may be blown until the excess isocyanate compound comes no longer to drip from the blade surface, by means of a blower having a nozzle of suitable orifice size (e.g., 1 mm) and a suitable blowing rate (e.g., 0.5 m³/minute). The warm gas or hot gas may be blown in a suitable way. For example, setting the nozzle stationary, the urethane resin blade (e.g., 330 mm in length) may be moved from its one end to the other end in front of the nozzle over a period of a suitable time (e.g., 30 seconds), keeping the distance between the nozzle tip and the urethane resin blade surface to a suitable one (e.g., 20 mm).

When the excess isocyanate compound is removed by further wiping it off with the solvent capable of dissolving the isocyanate compound, the solvent usable here may include, e.g., toluene, xylene, butyl acetate, and methyl ethyl ketone.

As a means for the removal, it may include, e.g., a method in which a sponge or the like not so hard as to scratch the urethane resin blade is soaked with the above solvent, and the excess isocyanate compound remaining on the urethane resin blade surface is wiped off therewith.

Here, if the solvent is used in a large quantity so that the excess isocyanate compound can be removed only by using the solvent, the isocyanate compound absorbed into unreacted urethane resin may come extracted to make it unable to form the cured layer stably at the surface portion. Accordingly, as an advance removal step, the above step is provided in which the excess isocyanate compound remaining on the surface is removed by means of the warm air or hot air blown at a temperature not lower than the melting point of the isocyanate compound, namely, the step of removing most of the isocyanate compound from the surface by blowing, e.g., hot air. Most of the excess isocyanate compound remaining on the surface is removed through this advance removal step, followed by the step of removing any remaining isocyanate compound from the surface by means of the sponge or the like soaked with the solvent in a necessary minimum quantity. This enables more preferable surface properties to be obtained.

Where the urethane resin has a large water content at the same time, the impregnation with the isocyanate compound inevitably causes urea reaction to proceed in which the water and the impregnating isocyanate compound react to cause foaming, so that the surface may come to have unevenness. Accordingly, in order to achieve good surface properties, it is better for the urethane resin to have water content as mall as possible, and it is preferable for the urethane resin to have a water content of 1% or less. In addition, as a method by which the urethane resin is made to have the water content of 1% or less, such a method as exemplified by heating drying or vacuum drying may be used.

After the above steps have been finished, the step (3) follows, where the urethane resin is allowed to react with the impregnating isocyanate compound. The impregnating isocyanate compound is almost lost as a result of the formation of allophanate linkages and because of the water content in the air, so that a whitish opaque cured layer is formed and the cleaning blade having smooth surface can be obtained.

With intention to accelerate the reaction in this step, the cleaning blade may be heated. Reaction temperature in this heating may preferably be 30° C. or more in usual cases, and may preferably be 140° C. or less, and reaction time may preferably be 5 minutes or more and may preferably be 100 minutes or less, from the viewpoint of reaction efficiency and prevention of heat deterioration of the urethane resin.

The isocyanate compound with which the urethane resin blade has been impregnated is almost lost as a result of the formation of allophanate linkages and because of the water content in the air. However, where the urethane resin blade has also been impregnated with the isocyanate compound in excess, the isocyanate compound remains in the urethane resin to make the cured layer have a larger thickness than necessary, so that its hardness and physical properties may change. Hence, after the cured layer has sufficiently been formed, the cured layer may preferably be allowed to react with an active hydrogen compound to deactivate unreacted isocyanate groups of the remaining isocyanate compound.

As the active hydrogen compound for deactivating unreacted isocyanate groups of the remaining isocyanate compound, a compound that reduces a load in a subsequent washing step may preferably be used, and an active hydrogen compound having a low molecular weight and a high volatility is preferred. In particular, it is unnecessary for the compound to be causative of cross-linking reaction with the isocyanate compound.

In addition, the compound causative of cross-linking reaction as referred to in the present invention is meant to be a compound having in one molecule a plurality of functional groups having active hydrogen. It enables a cross-linked structure to be formed together, with a plurality of isocyanate groups in the isocyanate compound.

In contrast thereto, the active hydrogen compound causative of no cross-linking reaction is meant to be a compound having in one molecule one functional group having active hydrogen, which may include monoalcohols, monoamines, monocarboxylic acids, monoaldehydes, ammonia and its aqueous solution, and water.

Where the cured layer has a further larger thickness, the degree of its friction with the toner holding member is proportionally reduced, compared with the urethane resin itself. Hence, the thickness of the cured layer can be regulated by controlling the reaction of the urethane resin with the isocyanate compound, so that the coefficient of friction thereof can also be regulated.

In the present invention, the cured layer is formed in a necessary minimum thickness, and hence the rubber elasticity at the blade tip is retained. Hence, the cleaning blade can be kept from having too high rigidity as a whole, thereby making it possible to realize good action following the toner holding member and superior cleaning performance. Also, good close-contact performance is achieved between the toner holding member and the cleaning blade, and the toner holding member is kept from being damaged by the cleaning blade.

In the present invention, an electrophotographic apparatus is also provided having the cleaning blade produced by the process which enables the cleaning blade to have a high hardness and a low coefficient of friction at its portion coming into contact with the toner holding member, and to have superior surface smoothness while maintaining good cleaning performance and durability.

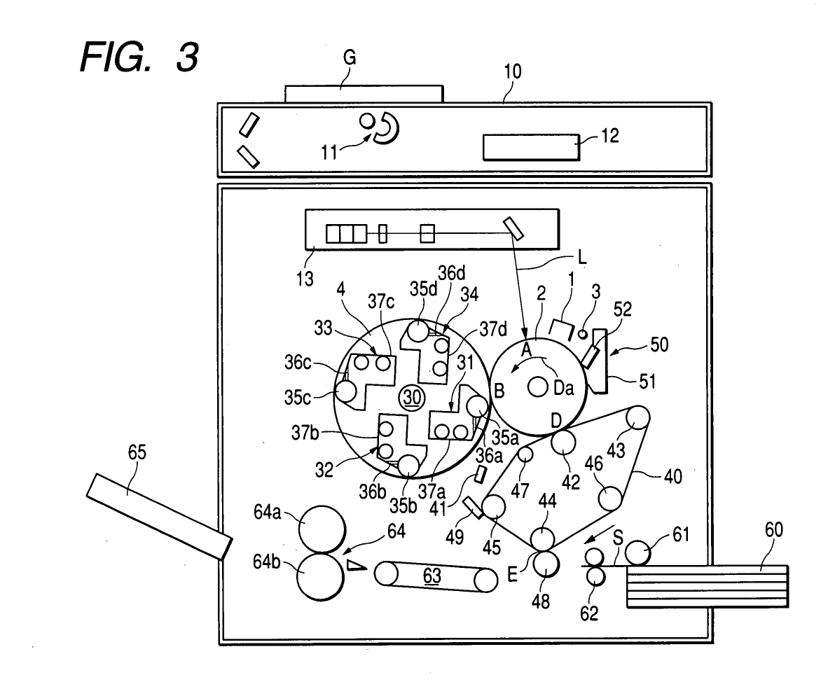

An example of such an electrophotographic apparatus in which the cleaning blade obtained by the process of the present invention is set is schematically shown in FIG. 3.

This apparatus has a photosensitive member 2, a charging means charging assembly 1, an exposure means ROS (image writing unit) 13, a developing means developing roll 4 having four developing assemblies 31 to 34, transfer means an intermediate transfer belt 40 and a secondary transfer assembly 48, a cleaning means cleaner 50, a charge elimination means pre-exposure unit 3, a fixing assembly 64, a paper feed-and-delivery system having members 60 to 62 and 65, and so forth.

An image-reading means has an original glass plate 10, a light source 11 which emits light to the original glass plate 10, a CCD (charge-coupled device) 12 which converts the light reflecting from the original glass plate 10, into electrical signals of red (R), green (G) and blue (B), and an IPS (image processing system) which receives the electrical signals of R, G and B inputted from the CCD to convert them into image data of black (K), yellow (Y), magenta (M) and cyan (C), and outputs to a laser beam generation unit the electrical signals corresponding to the images thus converted. Here, the letter symbol G in FIG. 3 denotes an original.

The developing assembly 31 has a developer container 37a holding therein a K two-component developer, a developing sleeve 35a provided rotatably at an opening of the developer container 37a, a control blade 36a which controls the developer held on the developing sleeve 35a to adjust the height of ears of a magnetic brush formed on the sleeve, a rotary rod for agitating the developer held in the developer container 37a, and a power source (not shown) which applies a voltage to the developing sleeve 35a at the time of development. Inside the developing sleeve 35a, a magnet member (not shown) having a plurality of magnetic poles is stationarily set. A developing assembly 32 holds therein a Y developer, a developing assembly 33 a M developer, and a developing assembly 34 a C developer, and these have the same construction as the developing assembly 31 except for the developers held therein.

The developing assemblies 31 to 34 are provided in a rotatable developing roll 4. The developing roll 4 is a roll which has a rotating shaft 30 and is rotated so that developing assemblies corresponding to color data of electrostatic latent images are transported to a developing zone B at the time of development. It constitutes a rotary-type developing means. By this developing roll 4, the developing sleeves 35a to 35d are so disposed that a magnetic brush on each developing sleeve can develop the electrostatic latent images in the state it comes into contact with the photosensitive member 2.

At the lower part of the photosensitive member 2, provided are an intermediate transfer belt 40, a plurality of belt-supporting rolls including a belt drive roll 45, a tension roll 43, idler rolls 46 and 47 and a back-up roll 44 for secondary transfer, a primary transfer roll 42, a belt frame (not shown) which support these, and a blade type belt cleaner 49 for removing any residual toner and so forth adhering to the intermediate transfer belt 40 before transfer.

At the position kept separate from the intermediate transfer belt 40, a position sensor 41 is provided which detects a home position provided at a non-transfer portion of the intermediate-transfer belt. Also, at the position facing the back-up roll 44 for secondary transfer via the intermediate transfer belt 40, a secondary transfer assembly 48 is provided which is to transfer the intermediately transferred toner images to a transfer material recording sheet.

The cleaner 50 has a cleaning blade 52 in contact with the surface of the photosensitive member 2, and a cleaning container 51 which holds the cleaning blade and receives toner particles and so forth removed by the cleaning blade.

The photosensitive member 2 is rotated in the direction of an arrow Da. Its surface is uniformly electrostatically charged by the charging assembly 1 and thereafter, at a latent-image writing position A, exposure-scanned by laser beams L (chief wavelength: 655 nm) emitted from the ROS 13, whereupon an electrostatic latent image is formed. In the case of full-color image formation, electrostatic latent images corresponding to the K (black), Y (yellow), M (magenta) and C (cyan) four-color images are sequentially formed. In the case of black monochromatic image formation, only an electrostatic latent image corresponding to the K (black) image is formed.

The photosensitive-member 2 surface on which the electrostatic latent images have been formed moves rotatingly and passes through a developing zone B and a primary transfer zone D successively. The developing assemblies 31 to 34 are transported to the developing position as the developing roll 4 is rotated, and make into toner images the electrostatic latent images formed on the photosensitive-member 2 surface passing through the developing zone B.

In the case of full-color image formation, a first-color electrostatic latent image is formed at the latent-image writing position A and the first-color toner image is formed at the developing zone B. This toner image is, when passing through the primary transfer zone D, electrostatically primarily transferred onto the intermediate transfer belt 40 by the aid of the primary transfer roll 42. Thereafter, on the intermediate transfer belt 40 holding the first-color toner image thereon, a second-color toner image, a third-color toner image and a fourth-color toner image are likewise sequentially superimposingly primary-transferred, and finally a full-color multiple toner image is formed on the intermediate transfer belt 40. In the case of monochromatic black-and-white image formation, only the developing assembly 31 is used, and a monochromatic toner image is primarily transferred onto the intermediate transfer belt 40.

After the primary transfer, the residual toner on the surface of the photosensitive member 2 is removed by means of the cleaning blade 52.

The recording sheets S held in a paper feed tray 60 are sheet by sheet taken out by a pick-up roll 61 at a given timing, and are each transported to a pair of registration rolls 62. The registration rolls 62 transport each recording sheet S to a secondary transfer zone E in synchronization with the movement of the primarily transferred multiple toner image or monochromatic toner image to the secondary transfer zone E. In the secondary transfer zone E, the secondary transfer assembly 48 electrostatically secondarily transfers the toner image(s) held on the intermediate transfer belt 40 at a time to the recording sheet S. The intermediate transfer belt 40 after the secondary transfer is cleaned by the belt cleaner 49, thus the residual toner on the belt is removed.

The recording sheet S to which the multiple or monochromatic toner image has been transferred is transported to the fixing assembly 64 by a sheet transport belt 63, and heat-fixed by a fixing assembly 64. The recording sheet S to which the toner image has been fixed is delivered to a recording sheet take-off tray 65.

In the present invention, in this electrophotographic apparatus, the cleaning blade defined in the present invention is used in which the above cleaning blade 52 has been cure-treated at its portion coming into contact with the photosensitive member 2, bringing about excellent effects. The cleaning blade according to the present invention is also usable in the belt cleaner 49.

### EXAMPLES

The present invention is described below by giving Examples.

### Example 1

A prepolymer (NCO: 7%) made from a butylene hexylene adipate type polyester polyol having a weight-average molecular weight of 2,000 and MDI was so mixed with a mixed cross-linking agent of 1,4-butanediol and trimethylol propane (weight ratio: 65:35) that the hydroxyl group/NCO molar ratio was 0.8, and the mixture obtained was molded into a blade of 330 mm in length and 2 mm in thickness (IRDH: 770). This blade was stuck to a support member sheet metal to make up a base member cleaning blade. In addition, a margin for sticking to the sheet metal was 5 mm, and the length of the blade in the free-length direction was 10 mm.

The base member cleaning blade thus obtained was subjected to preliminary drying (40° C./0.05 Pa or less, for 5 hours). Thereafter, up to 5 mm from the lower end of the blade, its urethane resin portion was immersed in an MDI (trade name: MILLIONATE; available from Nippon Polyurethane Industry Co., Ltd.; melting point: 380) bath (80° C.) for 5 minutes.

This cleaning blade was drawn up from the MDI bath, and thereafter hot air of 50° C. was blown until the isocyanate compound remaining on the cleaning blade surface came no longer to drip therefrom, by means of a blower to remove most of the MDI adhering to the cleaning blade surface. The hot air was blown under the following conditions: It was brown on the MDI-adhering cleaning blade surface from a nozzle of 1 mm in orifice size and at a rate of 0.5 m³/minute. Setting the nozzle stationary, the urethane resin blade of 330 mm in length was moved from its one end to the other end in front of the nozzle over a period of 30 seconds while the distance between the nozzle tip and the urethane resin blade surface was kept 20 mm.

After the treatment with the hot air, the surface of the resultant cleaning blade was wiped off and finished using a sponge soaked with a small quantity of toluene (wiping off with solvent), followed by drying.

Thereafter, this cleaning blade impregnated with the MDI was placed in a hot-air electric furnace to carry out heating at 80° C. for 30 minutes, and the blade thus heated was further left at room temperature for 2 days to obtain a cleaning blade having a milky-white cured layer.

The cleaning blade thus obtained was evaluated in the following way.

Ten-Point Average Roughness:

Measured with a surface roughness measuring instrument SURFCORDER SE3500 (manufactured by Kosaka Laboratory Ltd.)

Hardness of Cured Layer:

The hardness of the milky-white cured-layer portion of the urethane resin cleaning blade having the cured layer was measured with a Wallece Hardness Tester.

Thickness T of Cured Layer:

After an assemble test as described below was finished, the cleaning blade was cut, and the thickness of the milky-white portion of its section was observed by the use of an optical microscope to make measurement.

Water Content in Urethane Resin:

Measured with a Hiranuma automatic lubricating oil water content measuring system AQL-220 (manufactured by Hiranuma Sangyo K.K.)

Coefficient of Friction:

Under application of a load of 0.1 kg, a ball penetrator made of stainless steel was brought into contact with the portion having the cured layer, and the ball penetrator was moved at 50 mm/minute. With this setting, the coefficient of friction was measured with HEIDON Surface Properties Tester (manufactured by Shinto Kagaku K.K.).

Appearance:

Whether or not any wipe-off remains were present was visually examined.

Assemble Test:

The cleaning blade produced as described above was set in a color laser copying machine (trade name: CLC-5000, manufactured by CANON INC., and an extensive-operation test (running test) was conducted to ascertain cleaning performance appearing on images formed.

### Example 2

In Example 1, after the surface of the urethane resin cleaning blade was wiped off and finished using the sponge soaked with a small quantity of toluene, the blade was further subjected to immersion treatment in ethanol containing 3% by weight of ammonia at room temperature for 10 minutes, followed by drying to obtain a cleaning blade the surface of which was milky-white at the portion of the cured layer. Subsequently, evaluation was made in the same manner as in Example 1.

### Example 3

A cleaning blade was obtained in the same manner as in Example 1 except that, in Example 1, the temperature of the MDI bath was changed to 100° C. Subsequently, evaluation was made in the same manner as in Example 1.

### Comparative Example 1

A cleaning blade having a cured layer was obtained in the same manner as in Example 1 except that, in Example 1, the urethane resin blade was immersed in the MDI bath without preliminary drying and that the excess MDI was, without being removed by blowing the hot air, sufficiently wiped off with the sponge soaked with toluene. Subsequently, evaluation was made in the same manner as in Example 1.

### Comparative Example 2

Evaluation was made in the same manner as in Example 1, using the base member cleaning blade made of urethane resin, prepared in Example 1, to which the step of impregnation with the MDI and subsequent steps were not applied.

The evaluation results on these are shown in Table 1.

TABLE 1

| | | | | Comparative | |
|---|---|---|---|---|---|
| | Example | | | Example | |
| | 1 | 2 | 3 | 1 | 2 |
| Base member hardness: | 77 | 77 | 77 | 77 | 77 |
| (°) | | | | | |
| Preliminary drying: | done | done | done | undone | — |
| Water content: | 0.6-0.8 | 0.6-0.8 | 0.6-0.8 | 1.5-2.1 | — |
| (%) | | | | | |
| MDI temp.: | 80 | 80 | 100 | 80 | — |
| (° C.) | | | | | |
| Hot-wind removal (& | done | done | done | undone | — |
| wipe-off with solvent): | | | | | |
| Treatment with | undone | done | undone | undone | — |
| ammonia water: | | | | | |
| Rz: | 0.5-1.4 | 0.5-1.5 | 0.5-1.9 | 1.8-6.3 | 0.3-0.5 |
| (μm) | | | | | |
| Hardness of cured layer: | 80-83 | 81-83 | 83-85 | 80-87 | — |
| (°) | | | | | |
| Coefficient of friction: | 0.5-0.9 | 0.5-0.8 | 0.5-0.7 | 0.7-1.3 | 3.2 |
| Appearance (wipe-off remains): | non | non | non | present | — |
| Assemble test: | Good | Good | Good | Slip- | Blade |
| | cleaning | cleaning | cleaning | through | turn- |
| | performance | performance | performance | at | up on |
| | up to | up to | up to | wipe- | 20,000 |
| | 80,000 | 80,000 | 80,000 | off | sheet |
| | sheet | sheet | sheet | remain | copying. |
| | copying. | copying. | copying. | areas. | |

### Example 4

A cleaning blade was obtained in the same manner as in Example 1 except that, in Example 1, a 1.6 mm thick base member cleaning blade made of urethane resin was used which was obtained using a prepolymer (NCO: 6.0%) made from an ethylene butylene adipate type polyester polyol having a weigh-average molecular weight of 1,300 and MDI which were so mixed with a mixed cross-linking agent of 1,4-butanediol and trimethylol propane (weight ratio: 65:35) that the hydroxyl group/NCO molar ratio was 0.9. Evaluation was made in the same manner as in Example 1 except that the assembly test was conducted in the following way.

Assemble Test:

The cleaning blade produced as described above was set in a printer LASER SHOT LBP-850, (manufactured by CANON INC.), and an extensive-operation test (running test) was conducted to ascertain cleaning performance appearing on images formed.

### Comparative Example 3

A cleaning blade was obtained in the same manner as in Example 1 except that, in Example 1, the same one as produced in Example 4 was used as the base member cleaning blade in which the cured layer was to be formed. Subsequently, evaluation was made in the same manner as in Example 4.

The evaluation results in Example 4 and Comparative Example 3 are shown in Table 2.

TABLE 2

| | | Comparative |
|---|---|---|
| | Example 4 | Example 3 |
| Base member hardness: | 63 | 63 |
| (°) | | |
| Preliminary drying: | done | undone |
| Water content: | 0.4-0.6 | 1.5-2.0 |
| (%) | | |
| MDI temp.: | 80 | 80 |
| (° C.) | | |
| Hot-wind removal (& | done | undone |
| wipe-off with solvent): | | |
| Treatment with | undone | undone |
| ammonia water: | | |
| Rz: | 0.5-1.4 | 0.3-0.5 |
| (μm) | | |
| Hardness of cured layer: | 65-68 | 65-73 |
| (°) | | |
| Coefficient of friction: | 0.5-0.9 | 0.6-1.3 |
| Appearance (wipe-off remains): | non | present |
| Assemble test: | Good cleaning | Slip-through |
| | performance | in some cases. |
| | up to 80,000 | |
| | sheet printing. | |

As can be seen from Tables 1 and 2, the assemble tests in Examples 1 to 4 showed good results. In addition, most of the values of Rz of the cured layer surfaces (contact portion) were 1 μm or less, and, even in bad cases, none of them were not more than 2 μm.

On the other hand, in Comparative Examples 1 and 3, the removal of the excess isocyanate compound was insufficient (wipe-off remains were seen) in some cases, showing a tendency that Rz was large at wipe-off remain areas. As for the hardness, the hardness was likewise high at wipe-off remain areas, showing a little greater non-uniformity in hardness in Comparative Examples 1 and 3 than that in Examples 1 to 4.

Although wipe-off remains were seen in Comparative Examples 1 and 3, the coefficient of friction was made 50% or more lower than that of the solid urethane resin blade in Comparative Example 2, but was greatly non-uniform compared with those in Examples 1 to 4.

In the assemble tests, the cleaning blades of Examples 1 to 4 showed sufficient durability, whereas the slip-though of toner occurred in Comparative Examples 1 and 3, where images formed were a little inferior to those in Examples 1 to 4.

In Comparative Example 2, the coefficient of friction was so large that the blade turn-up occurred after extensive operation (running) on about 20,000 sheets.

What is claimed is:

1. A process for producing a cleaning blade; the process comprising the steps of:
(1) impregnating with an isocyanate compound at least part of the surface portion of a blade formed of a urethane resin;
(2) after the impregnation, blowing warm air or hot air on the blade surface to remove the isocyanate compound remaining on the blade surface; the warm air or hot air having a temperature not lower than the melting point of the isocyanate compound; and
(3) allowing the urethane resin that forms the blade to react with the isocyanate compound with which the blade stands impregnated, to form a cured layer.

2. The process for producing a cleaning blade according to claim 1, which further comprises, between the steps (2) and (3), the step of further removing with a solvent the isocyanate compound remaining on the blade surface.

3. The process for producing a cleaning blade according to claim 1, wherein the step (1) is carried out by immersing the blade in an isocyanate compound bath.

4. The process for producing a cleaning blade according to claim 1, wherein, in the step of impregnating the blade with an isocyanate compound, the urethane resin that forms the blade has a water content of 1% by weight or less.

5. The process for producing a cleaning blade according to claim 1, which further comprises the step of deactivating excess unreacted isocyanate groups with an active hydrogen compound causative of no cross-linking reaction.

6. A cleaning blade for electrophotography, produced by the process according to claim 1, wherein the cured layer has a ten-point average roughness Rz of 5 μm or less.

7. A cleaning blade produced by the process according to claim 1, wherein the cured layer has a hardness of from 60° to 90°.

8. A cleaning blade produced by the process according to claim 1, wherein the cured layer has a rubber hardness that is larger by 1° to 10° than the rubber hardness at the portion where the cured layer is not formed.

9. An electrophotographic apparatus in which the cleaning blade produced by the process according to claim 1 is set.

10. An electrophotographic apparatus according to claim 9, wherein the cured layer formed by allowing the urethane resin that forms the blade to react with the isocyanate compound with which the blade stands impregnated, is disposed in contact with a toner holding member.
